(19) United States
(12) Patent Application Publication
(10) Pub. No.: US 2014/0232680 A1
(43) Pub. Date: Aug. 21, 2014

(54) ELECTRONIC CARD AND CAPACITIVE TOUCH SENSING METHOD THEREOF

(71) Applicant: SMARTDISPLAYER TECHNOLOGY CO., LTD., Keelung City (TW)

(72) Inventor: Lee Chung LIN, Keelung City (TW)

(73) Assignee: SMARTDISPLAYER TECHNOLOGY CO., LTD., Keelung City (TW)

(21) Appl. No.: 13/865,872

(22) Filed: Apr. 18, 2013

(30) Foreign Application Priority Data
Feb. 20, 2013 (TW) 102105796

(51) Int. Cl. G06F 3/044

(52) U.S. Cl. CPC G06F 3/044
USPC 345/174

(57) ABSTRACT

An electronic card includes at least one integrated circuit (IC) and a manually controlled touch sensing means electrically connected to the IC, both of which are sealed in an isolation material layer. Multiple electrodes of the touch sensing means together constitute a capacitive touch area and respectively generate a capacitance value to the IC. The touch sensing means is spaced from two opposite contact surfaces of the electronic card by different distances. When a user touches at least one of the two contact surfaces of the electronic card, the IC determines the capacitance values generated by the electrodes corresponding to the touched positions, so as to verify whether a data or a command input by the user's touch is valid or not. Thus, accurate and correct input by touch can be performed on the electronic card without the need of providing an electric conduction shield in the electronic card.

### FIELD OF THE INVENTION

The present invention relates to a capacitive touch electronic card, and more particularly to an electronic display card that does not include any shielding structure while allows a user to accurately and correctly input by touching a capacitive touch area on the electronic card.

### BACKGROUND OF THE INVENTION

FIG. 1A shows a first conventional capacitive touch electronic card, which includes a printed circuit board (PCB) 10, on an upper surface of which a plurality of connection units (not shown) is provided and electrically connected to a power supply 11, so that electric power can be supplied from the power supply 11 to an integrated circuit (IC) 12 for use, enabling the electronic card to function like an electronic authentication means or an electronic device. There is also a plurality of capacitive electrodes 13 provided on the upper surface of the PCB 10 to allow touch operation by a user on the electronic card. An electric conduction shield 14 is provided on a lower surface of the PCB 10 without contacting with the capacitive electrodes 13, so that the electronic card does not sense and process any touch of the card on the lower surface thereof. A display unit 15 is electrically connected to the IC 12. Finally, the capacitive electrodes 13, the IC 12, the power supply 11, the connection units, and the electric conduction shield 14 are all sandwiched between two isolation material layers 16, 17 to complete the electronic card.

FIG. 1B shows a second conventional capacitive touch electronic card. The electric conduction shield 14 is not necessarily provided on the lower surface of the PCB 10 to space from the capacitive electrodes 13. As can be seen in FIG. 1B, the electric conduction shield 14 can be otherwise provided on, for example, one side of the isolation material layer 16 facing away from the capacitive electrodes 13 to effectively shield the capacitive electrodes 13 from sensing touches on the surface of the electronic card having the electric conduction shield 14 embedded in the isolation material layer 16. To additionally provide the electric conduction shield 14 in forming the electronic card would, however, complicate the card manufacturing procedures and also increase an overall thickness of the completed electronic card.

In view that the provision of the electric conduction shield would result in increased thickness and manufacturing cost of the conventional electronic display card, it is tried by the inventor to develop an improved electronic card and a capacitive touch sensing method thereof to overcome the disadvantages of the conventional electronic cards.

### SUMMARY OF THE INVENTION

A primary object of the present invention is to provide a capacitive touch electronic card, which does not internally include any electric conduction shield while allows a user to accurately and correctly input by touching a valid capacitive touch area on the electronic card.

Another object of the present invention is to provide an electronic card that omits an electric conduction shield therefrom to not only reduce the material and overall thickness of the electronic card, but also simplify the card manufacturing procedures to largely lower the manufacturing cost of the card.

To achieve the above and other objects, the electronic card according to the present invention includes at least one integrated circuit (IC) and a manually controlled touch sensing means electrically connected to the IC. The touch sensing means includes a plurality of electrodes, which together constitute a capacitive touch area and respectively generate a capacitance value to the IC for the latter to determine the validity of a touch in the capacitive touch area. And, the IC and the touch sensing means are sealed in at least one isolation material layer to complete the electronic card.

The electronic card according to the present invention is characterized in that the IC has a preset reference value, based on which the IC determines the validity of received capacitance values; and that the touch sensing means sealed in the isolation material layer is spaced from two opposite contact surfaces of the electronic card by different distances. Whereby, when a user touches at least one of the two contact surfaces of the electronic card, the IC determines according to the reference value the validity of the capacitance value generated by the electrode corresponding to the touched position and further determines whether a data or a command input by the user's touch is valid or not.

In a preferred embodiment of the present invention, the two contact surfaces of the electronic card are defined as a valid and an invalid touch surface according to their distance from the touch sensing means. That is, one of the two contact surfaces located closer to the touch sensing means is defined as a valid touch surface, while the other contact surface located farther from the touch sensing means is defined as an invalid touch surface. Further, the electronic card according to the present invention also includes a printed circuit board (PCB), a display unit, and a power supply.

The PCB is sealed in the isolation material layer to locate between the IC, the power supply and the touch sensing means. Further, the PCB is a flexible double-sided circuit board structure, and the touch sensing means is provided on a first side of the PCB while the IC and the power supply are provided on an opposite second side of the PCB. In an operable embodiment of the present invention, the PCB and the electrodes of the touch sensing means together form one single circuit board.

The display unit is sealed in the isolation material layer and electrically connected to the IC directly or indirectly via the PCB, which is also electrically connected to the IC. The isolation material layer includes a window section located at a position corresponding to a display surface of the display unit. In an operable embodiment of the present invention, the window section of the isolation material layer is configured as an opening or an area covered by a transparent material layer. The power supply is electrically connected to the PCB and supplies electric power to the IC, the display unit and the PCB.

Moreover, the electronic card according to the present invention can further include a manually driven operation unit, which is partially exposed from the isolation material layer and is electrically connected to the IC for controlling the touch sensing means and/or the display unit to operate or not to operate. In an operable embodiment of the present invention, the operation unit is configured as a switch button, which, when being manually pushed, actuates the touch sensing means and/or the display unit to operate.

A further object of the present invention is to provide an electronic card capacitive touch sensing method, so that an electronic card without an internal electric conduction shield can still determine the position and the validity of a touch on a card contact surface, so as to ensure accurate touch sensing ability of the electronic card.

To achieve the above and other object, the electronic card capacitive touch sensing method according to the present invention includes the steps of (i) providing an electronic card having a touch sensing means; the touch sensing means including a plurality of electrodes that together constitute a capacitive touch area, and being located closer to one of two opposite contact surfaces of the electronic card and accordingly, farther from the other contact surface; (ii) upon touches of the capacitive touch area of the electronic card on at least one of the two contact surfaces, the electrodes of the touch sensing means at the touched positions being induced to generate corresponding capacitance values; (iii) transmitting the generated capacitance values to an IC in the electronic card, and the IC determining whether the received capacitance values are higher than a preset reference value or not; and (iv) the IC further determining whether an input data or command corresponding to the touches of the capacitive touch area is valid or not according to comparison results from the previous step.

The two contact surfaces of the electronic card are defined as a valid and an invalid touch surface according to their distance from the touch sensing means. That is, one of the two contact surfaces located closer to the touch sensing means is defined as a valid touch surface, while the other contact surface located farther from the touch sensing means is defined as an invalid touch surface. In a preferred embodiment of the electronic card capacitive touch sensing method according to the present invention, every one of the electrodes generates a capacitance value; and the IC stores all the capacitance values in the form of a table, calculates based on data in the table corresponding to the touched positions, stores the calculated results, and shows a scan result for each of the electrodes in the table, so that the touched positions are respectively determined as valid or not according to the scan results corresponding thereto.

From the above description, it can be found the electronic card of the present invention is advantageous in that the touch sensing means sealed in the electronic card is located closer to one of the two opposite contact surfaces of the electronic card, so that touches on the two contact surfaces would induce the corresponding electrodes to generate different capacitance values. From these different capacitance values, the IC in the card is able to determine the validity of different touches, even if the electronic card is not internally provided with any electric conduction shield. The omission of the internal electric conduction shield from the electronic card enables reduced card material, simplified card manufacturing procedures, and largely lowered card manufacturing cost.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIGS. 1A and 1B are sectional views showing two conventional capacitive touch electronic cards internally provided with an electric conduction shield;

FIG. 2 is a sectional view of an electronic card according to a preferred embodiment of the present invention;

FIGS. 3A and 3B are sectional views showing the touch of a valid and an invalid contact surface, respectively, of the electronic card of the present invention;

FIG. 4 is a comparison diagram showing how an IC in the electronic card of the present invention determines the validity of received capacitance values;

FIG. 5 is a flowchart showing the steps included in an electronic card capacitive touch sensing method according to the present invention;

FIG. 6 is a schematic circuit diagram showing an electrical connection of an IC to a touch sensing means in the electronic card of the present invention; and

FIG. 7 is a table listing channel numbers and position codes assigned to different electrodes of the capacitive touch sensing means and scan results thereof.

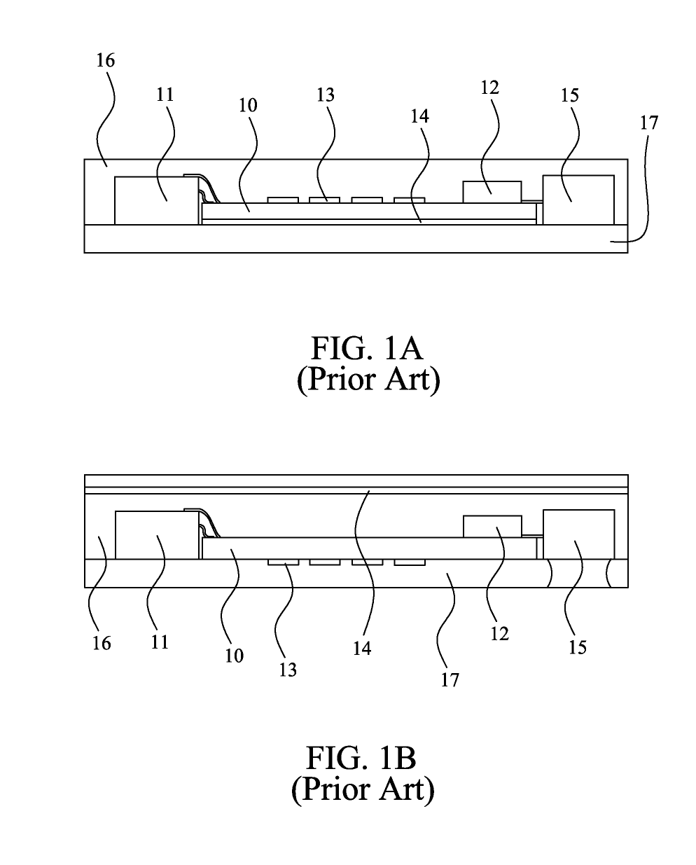

### DETAILED DESCRIPTION OF THE PREFERRED EMBODIMENTS

The present invention will now be described with a preferred embodiment thereof and with reference to the accompanying drawings.

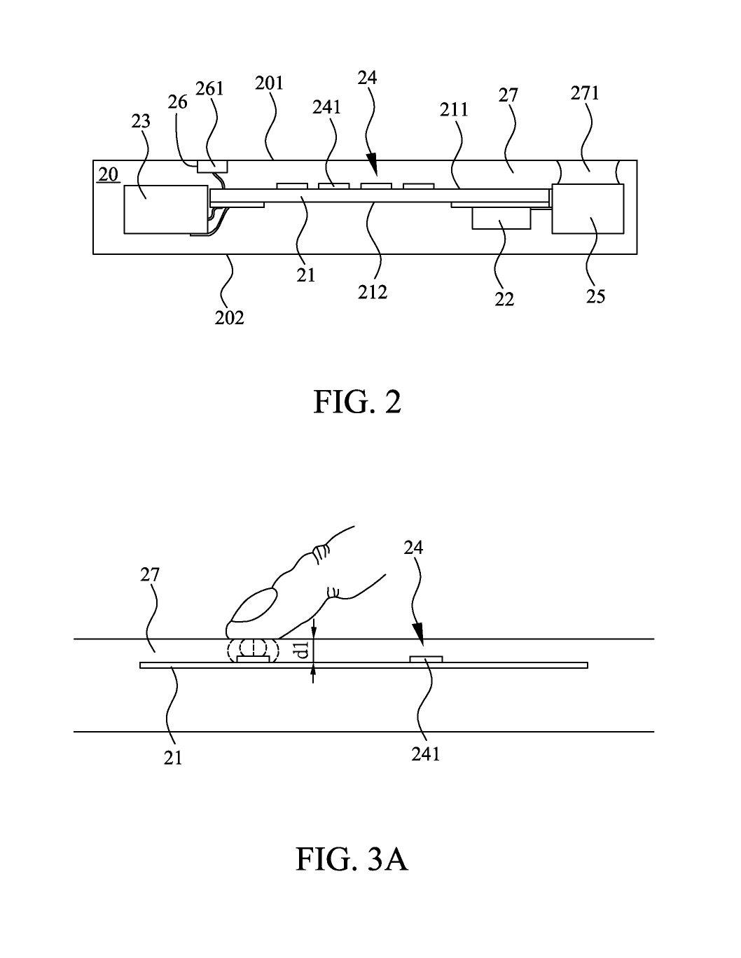

Please refer to FIG. 2 that is a sectional view of an electronic card 20 according to a preferred embodiment of the present invention. As shown, the electronic card 20 includes a printed circuit board (PCB) 21, at least one integrated circuit (IC) 22, a power supply 23, a manually controlled touch sensing means 24, a display unit 25, a manually driven operation unit 26, and at least one isolation material layer 27.

The PCB 21 is located between and electrically connected to the IC 22, the power supply 23, the touch sensing means 24, the display unit 25 and the operation unit 26, so that all the IC 22, the power supply 23, the touch sensing means 24, the display unit 25 and the operation unit 26 are indirectly connectable to one another via the PCB 21. In the illustrated preferred embodiment, the PCB 21 is a flexible double-sided circuit board structure; the touch sensing means 24 and the operation unit 26 are arranged on a first side 211 of the PCB 21, while the IC 22, the power supply 23 and the display unit 25 are arranged on an opposite second side 212 of the PCB 21.

The IC 22 is indirectly connected via the PCB 21 to the power supply 23, the touch sensing means 24 and the display unit 25, and has a preset reference value for determining the validity of a received capacitance value. The power supply 23 supplies electric power needed by the IC 22, the display unit 25 and the PCB 21 to operate. The touch sensing means 24 includes a plurality of electrodes 241 that together constitute a capacitive touch area and generate capacitance values to the IC 22, and the IC determines the validity of respective received capacitance values by comparing them with the reference value. The display unit 25 is electrically connected to the IC 22 for showing information about the electronic card 20.

It is understood the above description of the electronic card 20 is only illustrative to facilitate easy explanation of the present invention and not intended to limit the same in any way. For example, the display unit 25 is not necessarily directly connected to the IC 22, but can be directly connected to the PCB 21 and indirectly connected to the IC 22 via the PCB 21. Further, differently configured ICs 22 can be provided on the PCB 21, so that the electrodes 241 and the display unit 25 are respectively connected to a different IC 22.

In the illustrated preferred embodiment, the operation unit 26 is indirectly electrically connected to the IC 22 for controlling the touch sensing means 24 and/or the display unit 25 to operate or not to operate. The isolation material layer 27 in the illustrated preferred embodiment is a single-layer structure for encapsulating all the PCB 21, the IC 22, the power supply 23, the touch sensing means 24 and the display unit 25 while allowing the operation unit 26 to partially expose from the isolation material layer 27, so as to complete the electronic card 20 having two opposite contact surfaces, namely, a first contact surface 201 and an opposite second contact surface 202. It is noted the touch sensing means 24 encapsulated in the isolation material layer 27 is spaced from the first contact surface 201 and the second contact surface 202 by different distances.

Again, it is understood the above description of the electronic card 20 as including only one single isolation material layer 27 is only illustrative and not intended to limit the present invention in any way. That is, two or multiple isolation material layers 27 may be provided to encapsulate respective elements to complete a multilayered electronic card 20.

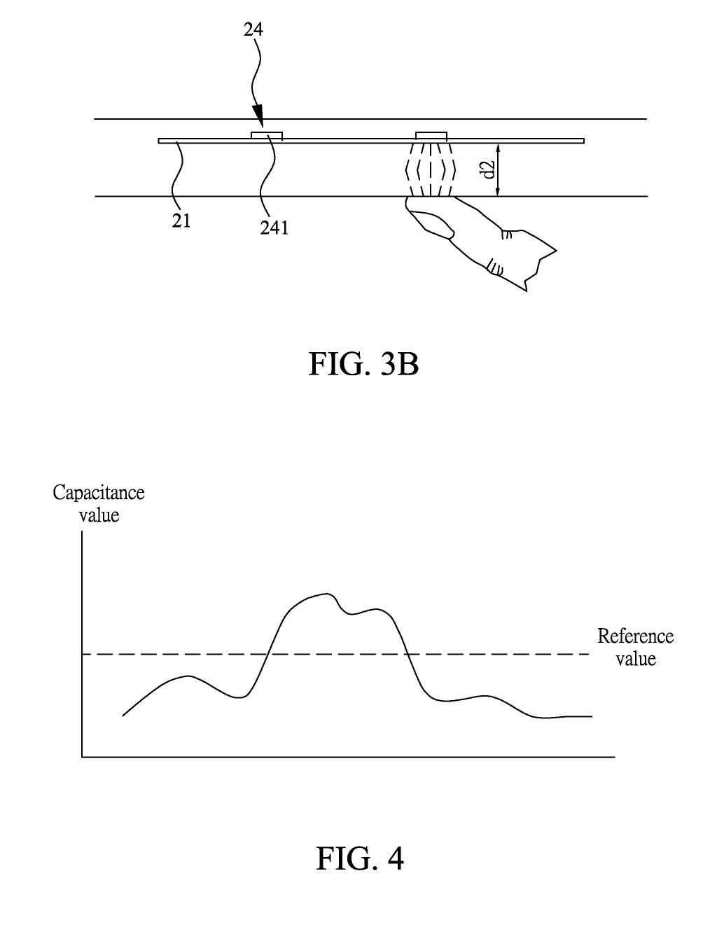

Please refer to FIGS. 3A and 3B. For example, as shown in FIG. 3A, when a user touches the first contact surface 201, which is the upper side of the electronic card 20 in the illustrated figure and closer to the touch sensing means 24, a distance between the first contact surface 201 and the electrode 241 corresponding to the touched position is denoted by d1. On the other hand, as shown in FIG. 3B, when the user touches the second contact surface 202, which is the lower side of the electronic card 20 in the illustrated figure and farther from the touch sensing means 24, a distance between the second contact surface 202 and the electrode 241 corresponding to the touched position and is denoted by d2. Then, the induced capacitance of the electrode can be calculated with the following equation:

$$C = \frac{\text{?} A}{d}$$

$$\text{?} \text{indicates text missing or illegible when filed}$$

where, C is the capacitance value, ∈ is the dielectric constant, A is the touched area, and d is the distance between the touched position and the contact surface.

It can be easily found from the above equation that the capacitance value increases when the distance d is reduced and decreases when the distance d is increased. Please refer to FIG. 4. Since the capacitance value varies with the distance, and since the distance d1 between the touch sensing means 24 and the upper side or the first contact surface 201 of the electronic card 20 is smaller than the distance d2 between the touch sensing means 24 and the lower side or the second contact surface 202 of the electronic card 20, there would be higher induced capacitance values and lower induced capacitance values when the electronic card 20 is touched by the user on both sides. Therefore, a curve of the induced capacitance values shown in FIG. 4 includes some upward projected sections representing the higher induced capacitance values. As shown in FIG. 4, a line representing the reference value used by the IC 22 for determining the validity of touch is located between the high and low capacitance values. Therefore, the capacitance values lower than the reference value, which are induced when the user touches the lower side of the electronic card 20 that is farther from the touch sensing means 24, are considered as generated from an invalid input; and the capacitance values higher than the reference value, which are induced when the user touches the upper side of the electronic card 20 that is closer to the touch sensing means 24, are considered as generated from a valid input. Therefore, one of the two contact surfaces on the electronic card 20 located closer to the touch sensing means 24, i.e. the first contact surface 201 in the illustrated preferred embodiment, is a valid touch surface; and the other contact surface located farther from the touch sensing means 24, i.e. the second contact surface 202 in the illustrated preferred embodiment, is an invalid touch surface.

With the present invention, when the user touches at least one of the two contact surfaces 201, 202 of the electronic card 20, the IC 22 determines the capacitance values generated by the electrodes 241 corresponding to the touched positions and further determines based on the received capacitance values whether the touched contact surface is a valid or an invalid touch surface, so as to verify whether an input data or command corresponding to the touch is valid or not.

In a preferred embodiment of the present invention, the isolation material layer 27 includes a window section 271 located at a position corresponding to a display surface of the display unit 25. In an operable embodiment, the window section 271 is configured as an opening or an area covered by a transparent material layer; and the operation unit 26 is configured as a switch button 261, which, when being manually pushed, actuates the touch sensing means 24 and/or the display unit 25 to operate.

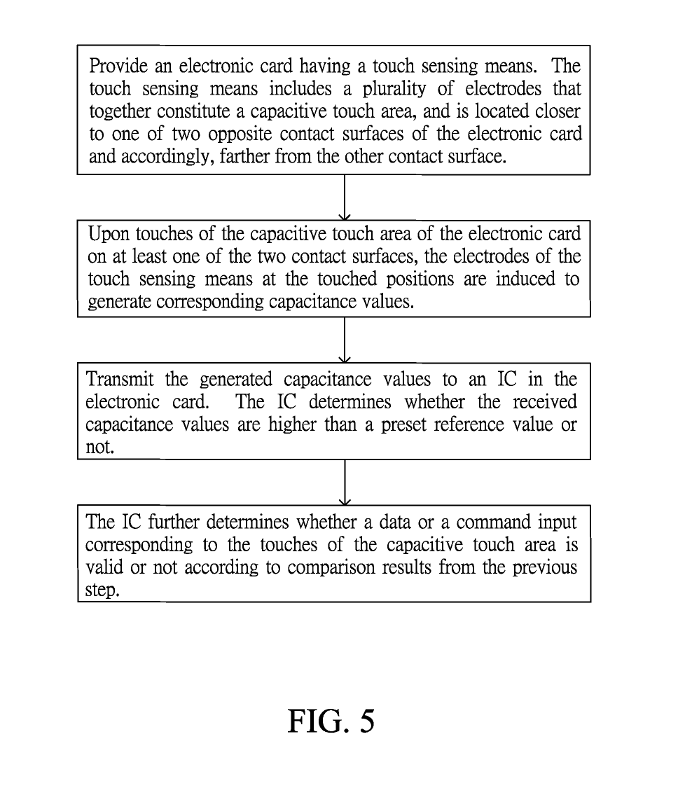

The present invention also provides an electronic card capacitive touch sensing method. FIG. 5 is a flowchart showing the steps includes in the electronic card capacitive touch sensing method according to the present invention. As shown, in a first step, an electronic card 20 including a touch sensing means 24 is provided. The touch sensing means 24 includes a plurality of electrodes 241 that together constitute a capacitive touch area, and is located closer to one of two opposite contact surfaces 201, 202 of the electronic card 20 and accordingly, farther from the other contact surface. In a second step, upon touches of the capacitive touch area of the electronic card on at least one of the two contact surfaces, the electrodes of the touch sensing means 24 at the touched positions are induced to generate corresponding capacitance values. In a third step, the generated capacitance values are transmitted to an IC 22 in the electronic card 20, and the IC 22 determines whether the received capacitance values are higher than a preset reference value. In a fourth step, the IC 22 determines whether an input data or command corresponding to the touches is valid or not according to results from the comparison of the received capacitance values with the reference value.

The two contact surfaces 201, 202 of the electronic card 20 are defined as a valid and an invalid touch surface according to their distance from the touch sensing means 24. That is, one of the two contact surfaces 201, 202 located closer to the touch sensing means 24 is defined as a valid touch surface, while the other contact surface located farther from the touch sensing means 24 is defined as an invalid touch surface. According to the present invention, all operational motions performed on the valid touch surface would actuate the execution of subsequent motions, while the operational motions performed on the invalid touch surface are directly omitted and no other subsequent motion would be executed.

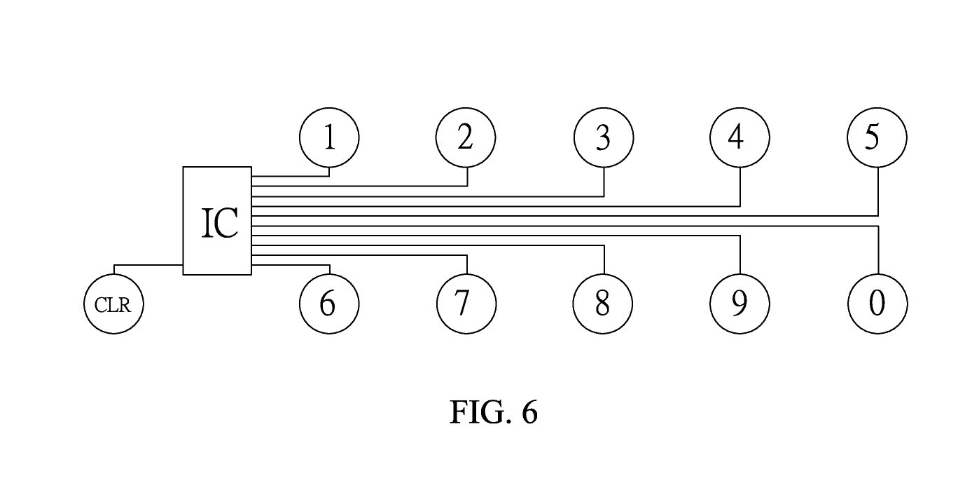

Please refer to FIG. 6. In the illustrated preferred embodiment, the touch sensing means 24 includes ten electrodes 241, which are respectively assigned one of ten position codes 0˜9 according to their positions in the capacitive touch area. Further, the position codes 0˜9 are respectively electrically connected to the IC 22 via a specific one of ten channels 0˜9. When the electronic card 20 of the present invention is in an active state, every electrode 241 continuously generates a capacitance value to the IC 22.

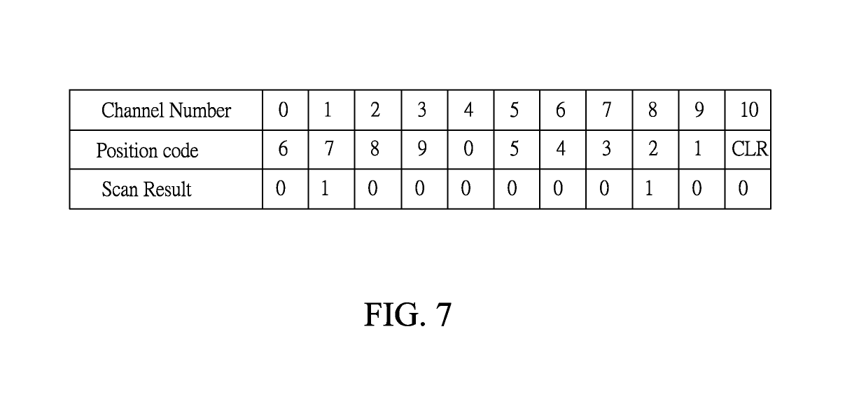

Please refer to FIG. 7. The IC 22 stores all the received capacitance values in the form of a table, and calculates according to data in the table to show a scan result for each of the positions, so as to verify the validity of the touched positions. Wherein, the scan result 1 represents the electrode 241 corresponding thereto generates a capacitance value higher than the reference value, and the scan result 0 represents the electrode 241 corresponding thereto generates a capacitance value lower than the reference value.

As shown in FIG. 7, in the illustrated preferred embodiment of the present invention, the IC 22 detects valid input operations at channel 1 that is connected to the electrode 241 having the position code of 7 and channel 8 that is connected to the electrode 241 having the position code of 2. In other words, the scan results indicate the valid touch surface of electronic card 20 is touched by a user at positions corresponding to position codes 7 and 2 to input data or command. With these arrangements, accurate and correct input by touch can be performed on the electronic card 20 without the need of providing an electric conduction shield in the electronic card.

The present invention has been described with a preferred embodiment thereof and it is understood that many changes and modifications in the described embodiment can be carried out without departing from the scope and the spirit of the invention that is intended to be limited only by the appended claims.

What is claimed is:

1. An electronic card, comprising at least one integrated circuit (IC) and a manually controlled touch sensing means electrically connected to the IC, the touch sensing means including a plurality of electrodes that together constitute a capacitive touch area and respectively generate a capacitance value to the IC for the latter to determine the validity of any touch in the capacitive touch area, and the IC and the touch sensing means being sealed in at least one isolation material layer to complete the electronic card, being characterized in that:
the IC has a preset reference value, based on which the IC determines the validity of received capacitance values; and
the touch sensing means sealed in the isolation material layer is spaced from two opposite contact surfaces of the electronic card by different distances;
whereby when a user touches at least one of the two contact surfaces of the electronic card, the IC determines according to the reference value the validity of the capacitance value generated by the electrode corresponding to the touched position and further determines whether a data or a command input by the user's touch is valid or not.

2. The electronic card as claimed in claim 1, further comprising a printed circuit board (PCB); and the PCB being sealed in the isolation material layer to locate between the IC and the touch sensing means.

3. The electronic card as claimed in claim 2, further comprising a display unit; and
the display unit being sealed in the isolation material layer and electrically connected to the IC directly or indirectly via the PCB, which is electrically connected to the IC.

4. The electronic card as claimed in claim 3, wherein the isolation material layer includes a window section located at a position corresponding to a display surface of the display unit.

5. The electronic card as claimed in claim 4, wherein the window section of the isolation material layer is selected from the group consisting of an opening and an area covered by a transparent material layer.

6. The electronic card as claimed in claim 2, wherein the PCB is a flexible double-sided circuit board structure, and the touch sensing means being provided on a first side of the PCB while the IC being provided on an opposite second side of the PCB.

7. The electronic card as claimed in claim 2, wherein the PCB and the electrodes of the touch sensing means together form one single circuit board.

8. The electronic card as claimed in claim 3, further comprising a power supply; and the power supply being electrically connected to the PCB and supplying electric power to the IC, the display unit and the PCB.

9. The electronic card as claimed in claim 3, further comprising a manually driven operation unit; and the operation unit being partially exposed from the isolation material layer and being electrically connected to the IC for controlling the touch sensing means and/or the display unit to operate.

10. The electronic card as claimed in claim 9, wherein the operation unit is configured as a switch button, which, when being manually pushed, actuates the touch sensing means and/or the display unit to operate.

11. The electronic card as claimed in claim 1, wherein the two contact surfaces of the electronic card are defined as a valid and an invalid touch surface according to their distance from the touch sensing means; one of the two contact surfaces located closer to the touch sensing means being defined as a valid touch surface, while the other contact surface located farther from the touch sensing means being defined as an invalid touch surface.

12. An electronic card capacitive touch sensing method, comprising the steps of:
providing an electronic card having a touch sensing means; the touch sensing means including a plurality of electrodes that together constitute a capacitive touch area, and being located closer to one of two opposite contact surfaces of the electronic card and accordingly, farther from the other contact surface;
upon touches of the capacitive touch area of the electronic card on at least one of the two contact surfaces, the electrodes of the touch sensing means at the touched positions being induced to generate corresponding capacitance values;
transmitting the generated capacitance values to an IC in the electronic card, and the IC determining whether the received capacitance values are higher than a preset reference value; and
the IC determining whether an input data or command corresponding to the touches of the capacitive touch area is valid or not according to comparison results from the previous step.

13. The electronic card capacitive touch sensing method as claimed in claim 12, wherein every one of the electrodes generates a capacitance value; and the IC storing all the capacitance values in the form of a table and calculating based on data in the table to show a scan result for each of the electrodes, so that the touched positions are respectively determined as valid or not according to the scan results corresponding thereto.

14. The electronic card capacitive touch sensing method as claimed in claim 12, wherein the two contact surfaces of the electronic card are defined as a valid and an invalid touch surface according to their distance from the touch sensing means; one of the two contact surfaces located closer to the touch sensing means being defined as a valid touch surface, while the other contact surface located farther from the touch sensing means being defined as an invalid touch surface.
